(19) United States
(12) Patent Application Publication
(10) Pub. No.: US 2020/0093665 A1
(43) Pub. Date: Mar. 26, 2020

(54) Assistive Apparatus With An Adjustable Backrest Assembly

(71) Applicant: Brian Schwab, Each Chatham, NY (US)

(72) Inventor: Brian Schwab, (US)

(73) Assignee: Brian Schwab, Each Chatham, NY (US)

(21) Appl. No.: 16/581,747

(22) Filed: Sep. 24, 2019

Related U.S. Application Data
(60) Provisional application No. 62/735,855, filed on Sep. 24, 2018.

(51) Int. Cl. A61G 5/10; A61G 5/14; A61G 5/12; A47K 13/10

(52) U.S. Cl. CPC A61G 5/1002; A47K 13/10; A61G 5/122; A61G 5/14

(57) ABSTRACT

An assistive apparatus with a backrest assembly is disclosed to solve one of the problems of conventional toilet seats in lacking proper back support for individuals. The assistive apparatus also helps to put individuals sitting further forward to help the individuals to use the toilet much more easily. The assistive apparatus provides an adjustable toilet backrest assembly for supporting a human back. The backrest assembly includes a backrest pad, a top support frame connected to the backrest pad, and a bottom support frame. The backrest pad is designed to relieve pressure on the back of a person. The back support portion comprises a backrest frame and a back pad attached on the backrest frame for supporting the human back. The backrest frame provides means for adjusting height of the back pad to accommodate different height of the human back. The angle adjustment portion connects to the back support portion with the toilet mounting portion and provides an angle adjustment means for different position of sitting on toilet.

### CROSS-REFERENCES TO RELATED APPLICATIONS

This application claims priority from U.S. Provisional Application Ser. No. 62/735,855 filed Sep. 24, 2018, which is hereby incorporated herein by reference in the respective in its entirety.

### BACKGROUND OF THE INVENTION

Embodiments of the present invention generally relate to an assistive apparatus with an adjustable backrest assembly.

### Description of the Related Art

Conventionally, toilet seats lacking proper back support for individuals. Therefore, an assistive apparatus with an adjustable backrest assembly to be placed atop of a toilet is desirable so as to relieve users' pressure on the back.

### SUMMARY OF THE INVENTION

The present invention generally an assistive apparatus and a method of using the assistive apparatus. In one embodiment, the assistive apparatus includes a back rest assembly having a back rest pad, a top support frame connected to the back rest pad, a bottom support frame connected to the top support frame with one or more fastening knobs, and a support frame mounting base connected to the bottom support frame. In another embodiment, the one or more adjustable knobs are capable of moving from a first vertical position where the top support frame is at a base height (“H₀”) to a second vertical position where the top support frame is at a desirable height (“H₁”).

In still another embodiment, the top support frame is designed to be angled at an angle (“r”) between the top support frame and a vertical line (C-C′), and wherein the angle “r” is between zero to 45 degree. In one aspect, the assistive apparatus may further include one or more back supporting legs connected to the support frame mounting base. In another aspect, the assistive apparatus further includes one or more floor mounting flanges, where each back supporting leg is substantially vertical and physically joined to the one or more floor mounting flanges.

In a further embodiment, the assistive apparatus further includes one or more angle adjusting fastening knobs connected to the bottom support frame and the support frame mounting base, where the one or more angle adjust knobs are adapted to adjust an angle (“β”) between the bottom support frame and an vertical line (C-C′). For example, the angle “β” may be an angle “β₁”, ranging between zero degree to 89 degree. As another example, the angle “β” may equal to an angle “β₂”, ranging between zero degree to negative 89 degree.

In addition, the assistive apparatus further includes a buttock-spreading mechanism. Also, the assistive apparatus may also include one or more front supporting legs connected the buttock-spreading mechanism. In one aspect, a front bar is connected to the one or more front supporting legs to provide structural support for the one or more front supporting legs.

In one embodiment, the buttock-spreading mechanism includes an assistive platform, a right leaflet being positioned on a top side of the assistive platform and connected to the one or more actuators within the leaflet support housing, and a left leaflet being positioned on the top side of the assistive platform and connected to the one or more actuators within the leaflet support housing. In addition, the one or more actuators are adapted to adjust a horizontal distance (“H”) between the left leaflet and the right leaflet, wherein the horizontal distance (“H”) is adjustable between a first horizontal distance (“H₁”) and a second horizontal distance (“H₂”).

In another embodiment, the assistive apparatus further includes a lifting mechanism being connected to the buttock-spreading mechanism and adapted to lift the buttock-spreading mechanism. The lifting mechanism may include one or more lifting shafts adapted to lift the buttock-spreading mechanism so as to position an assistive platform of the buttock-spreading mechanism to be tilted at an angle (“α”). For example, the “α” angle may be adjusted to be between 0° and 80°.

In another embodiment, the lifting assembly may include one or more ball screw linear actuators and one or more nuts connected to the one or more lifting shafts.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. The drawings are not necessarily to scale. The drawings are merely schematic representations, not intended to portray specific parameters of the invention.

FIG. 1A is a perspective view of one example of an assistive apparatus having an adjustable backrest assembly and a buttock-spreading mechanism adapted to be positioned in a horizontal position according to an embodiment of the invention.

FIG. 1B is a perspective view of the assistive apparatus of FIG. 1A where the buttock-spreading mechanism is adapted to be positioned in an elevated position on top of a toilet according to an embodiment of the invention.

FIG. 1C is a perspective view of the assistive apparatus of FIG. 1A, where the buttock-spreading mechanism one example of a top portion of a buttock-spreading mechanism having two adjustable leaflets with adjustable backrest according to an embodiment of the invention.

FIG. 1D is a perspective view of operating a buttock-spreading mechanism to adjust and expand a distance between the two leaflets according to still another embodiment of the invention.

FIG. 2 is a side view of one example of an assistive toilet seat apparatus with adjustable backrest at highest position, wherein the height is “H₁”, according to one embodiment of the invention.

FIG. 3 is a side view of another example of an assistive toilet seat apparatus with adjustable backrest at lowers position, wherein the height is “H₀”, according to one embodiment of the invention.

FIG. 4A is a perspective view of one example of an assistive model of the adjustable backrest at lowest position, wherein the height is “H₀”, according to another embodiment of the invention.

FIG. 4B is a perspective view of another example of an assistive model of the adjustable backrest at highest position, wherein the height is “H₁”, according to still another embodiment of the invention in a horizontal state.

FIG. 5A is a perspective view of one example of a universal model of the adjustable backrest at lowest position, wherein the height is “H₀”, according to another embodiment of the invention.

FIG. 5B is a perspective view of another example of a universal model of the adjustable backrest at highest position, wherein the height is “H₁”, according to still another embodiment of the invention in a horizontal state.

FIG. 6A is a side view of one example of a universal model of the adjustable backrest at lowest position, wherein the height is “H₀”, according to another embodiment of the invention shown in a vertical state.

FIG. 6B is a side view of another example of a universal model of the adjustable backrest at highest position, wherein the height is “H₁”, according to still another embodiment of the invention shown in a vertical state.

FIG. 6C is a side view of still another example of a universal model of the adjustable backrest at lowest position, wherein the height is “H₀”, according to another embodiment of the invention shown in a backward tilt state (at an angle “β₁”).

FIG. 6D is a side view of still another example of a universal model of the adjustable backrest at highest position, wherein the height is “H₁”, according to still another embodiment of the invention shown in a backward tilt state (at an angle “β₁”.

FIG. 6E is a side view of yet another example of a universal model of the adjustable backrest at lowest position, wherein the height is “H₀”, according to still another embodiment of the invention shown in a forward tilt state (at an angle “β₂”).

FIG. 6F is a perspective view of yet another example of a universal model of the adjustable backrest at highest position according to still another embodiment of the invention shown in a forward tilted position.

FIG. 7A is a side view of one example of a backrest assembly with operating an angle adjustment mechanism mounted on a toilet to be in an original vertical position, a backward tilted position (tilted at an angle “β₀”), or a forward tilted state (at an angle “β₁” according to another embodiment of the invention).

FIG. 7B is a perspective view of another example of a universal model of the adjustable backrest mounted on a toilet backrest at highest position, wherein the height is “H₁”, according to another embodiment of the invention.

FIG. 7C is a front view of still another example of a universal model of the adjustable backrest mounted on a toilet backrest at highest position, wherein the height is “H₁”, according to still another embodiment of the invention.

FIG. 8A is a top view of one example of a universal model of the adjustable backrest according to another embodiment of the invention.

FIG. 88 is a back perspective view of another example of a backrest assembly according to yet another embodiment of the invention.

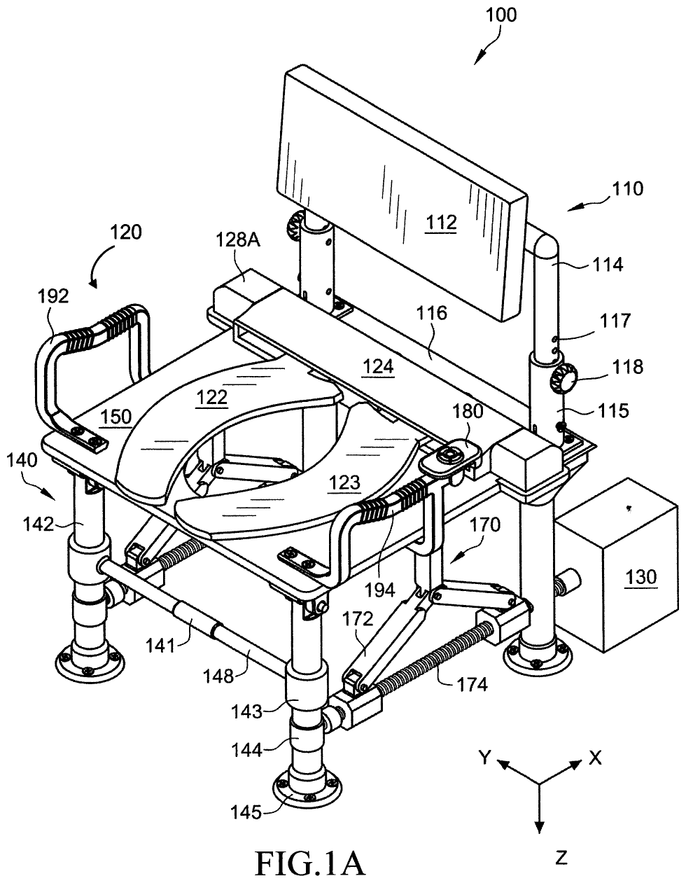

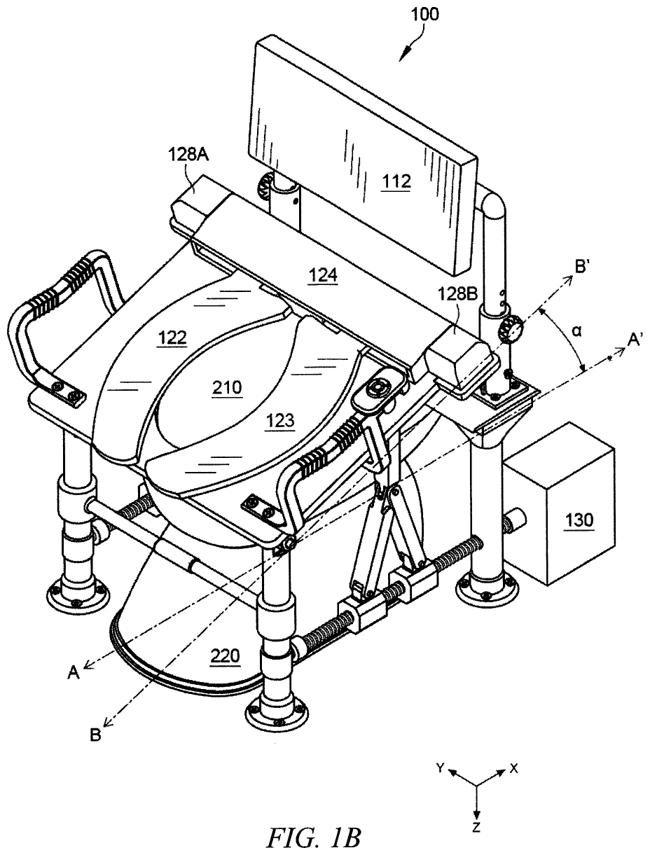

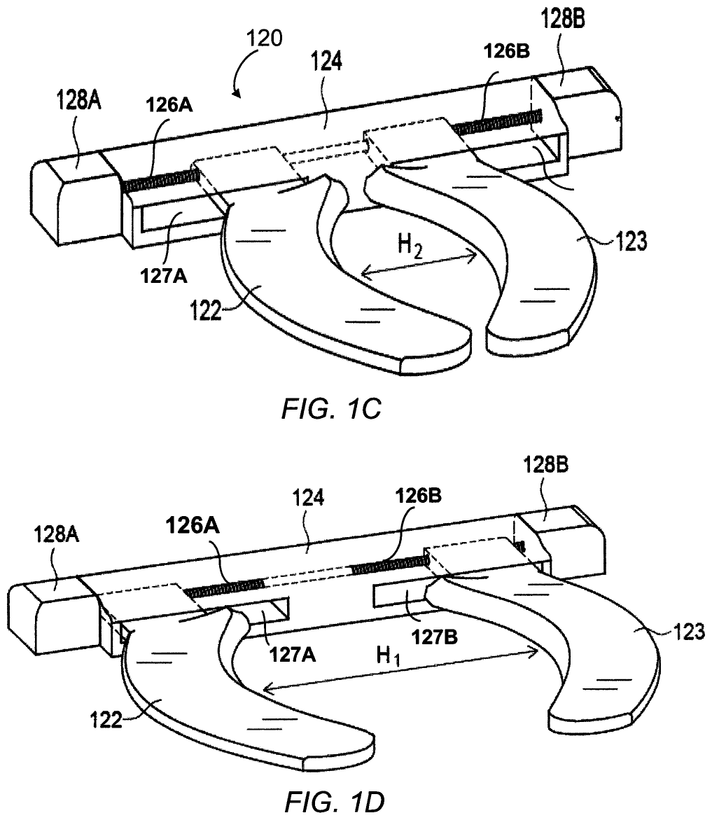

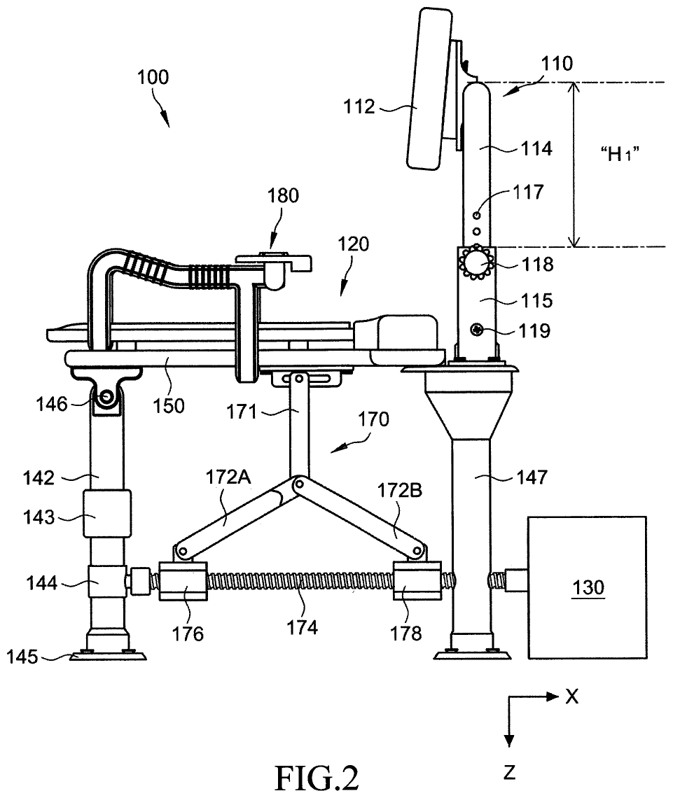

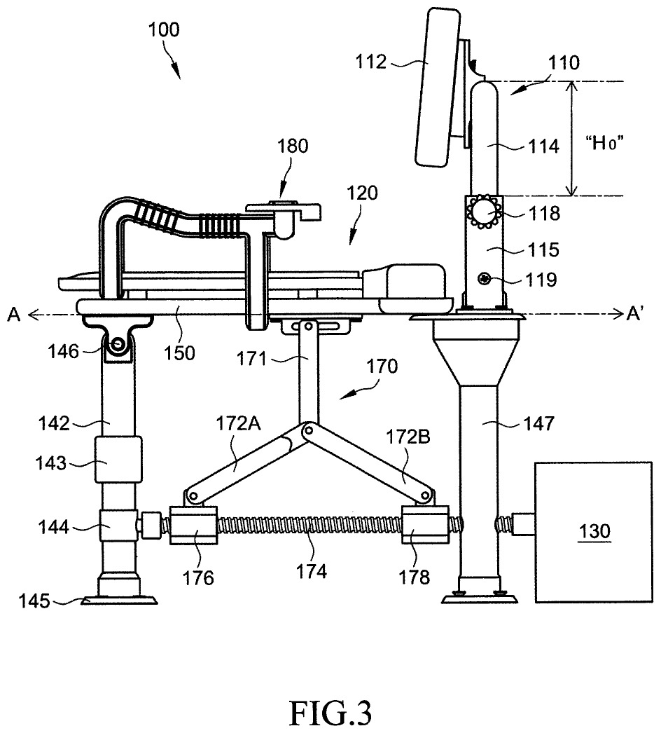

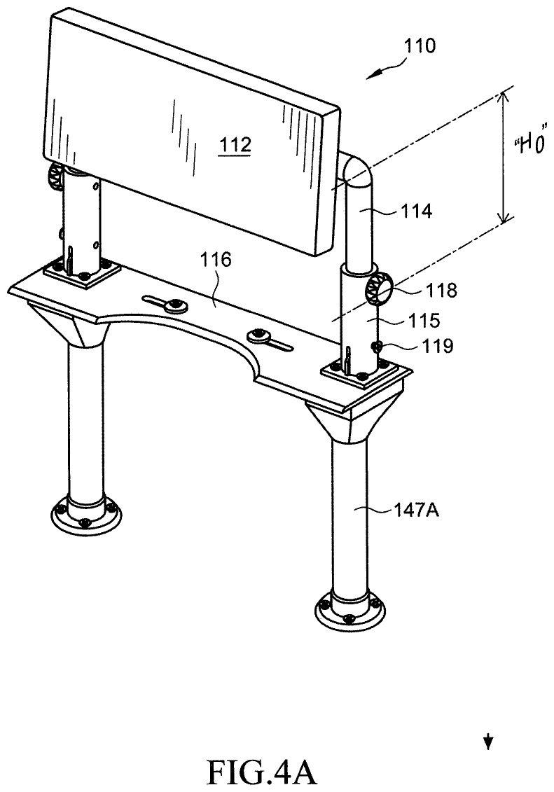

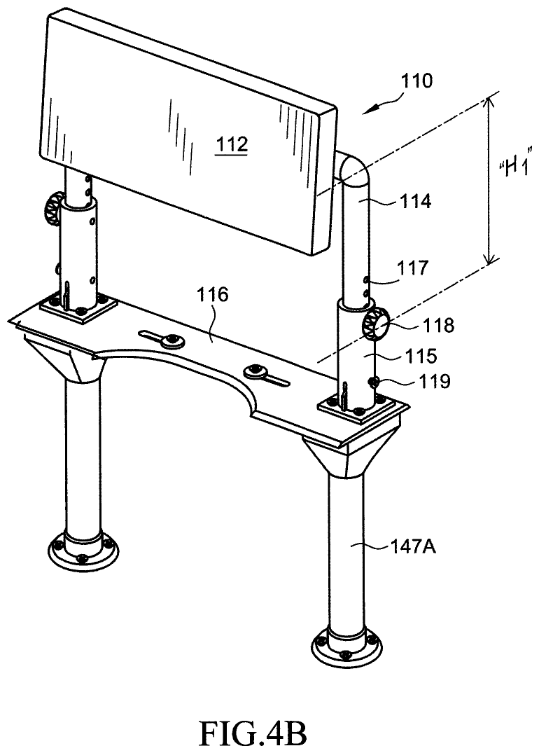

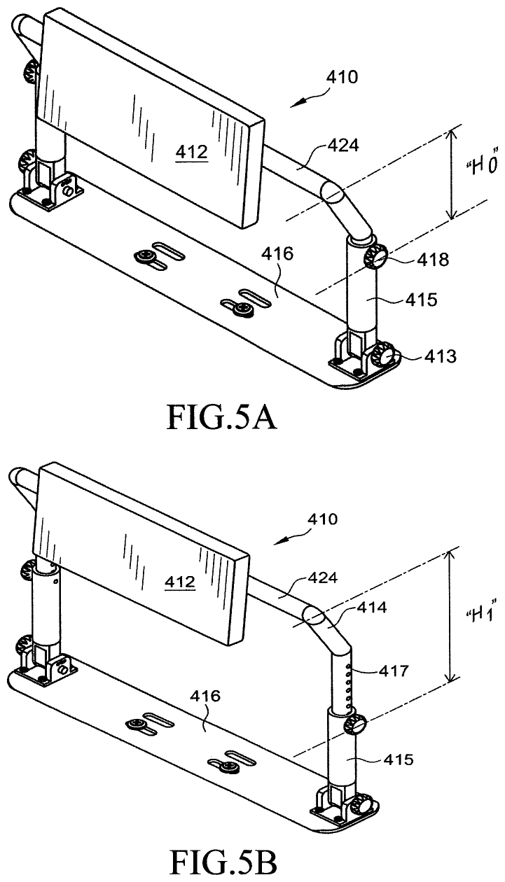

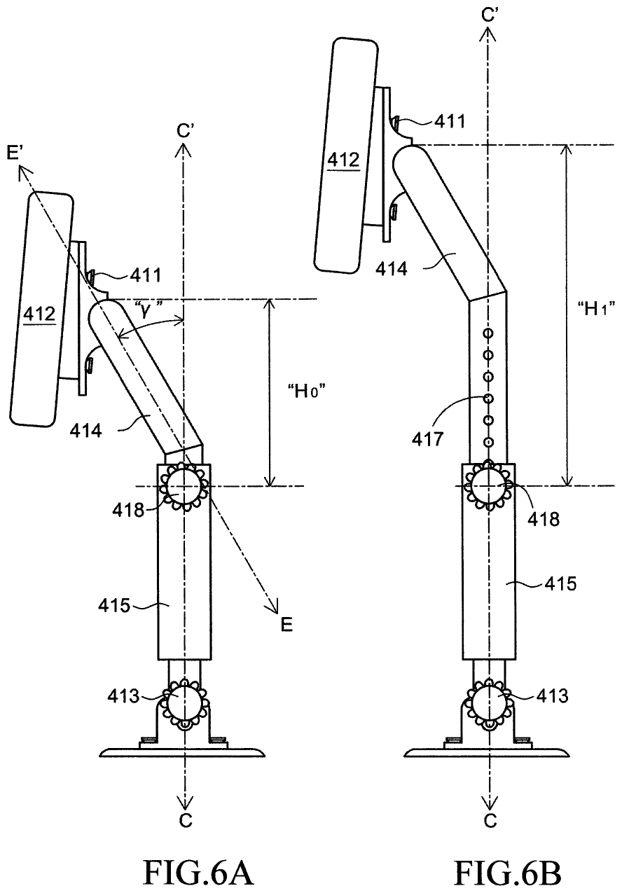

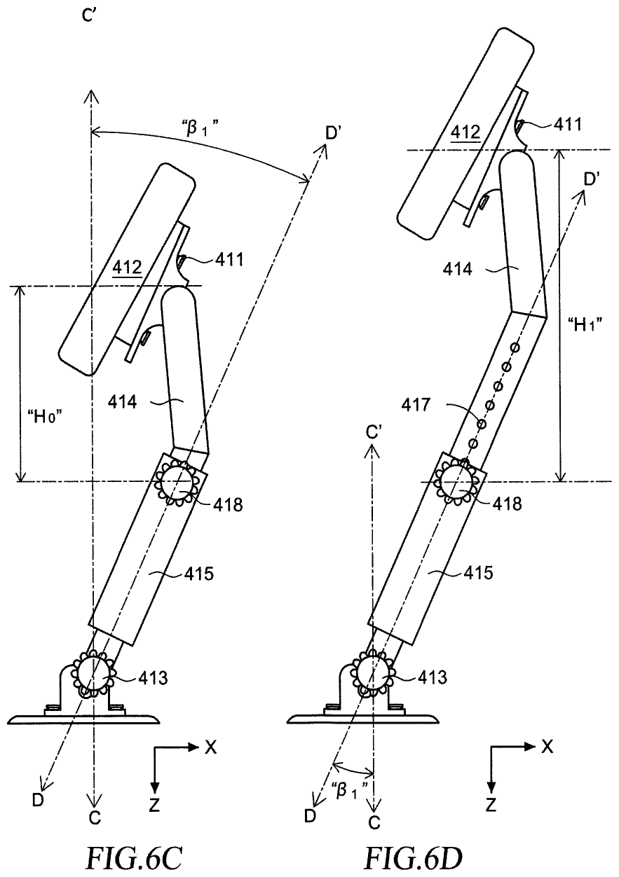

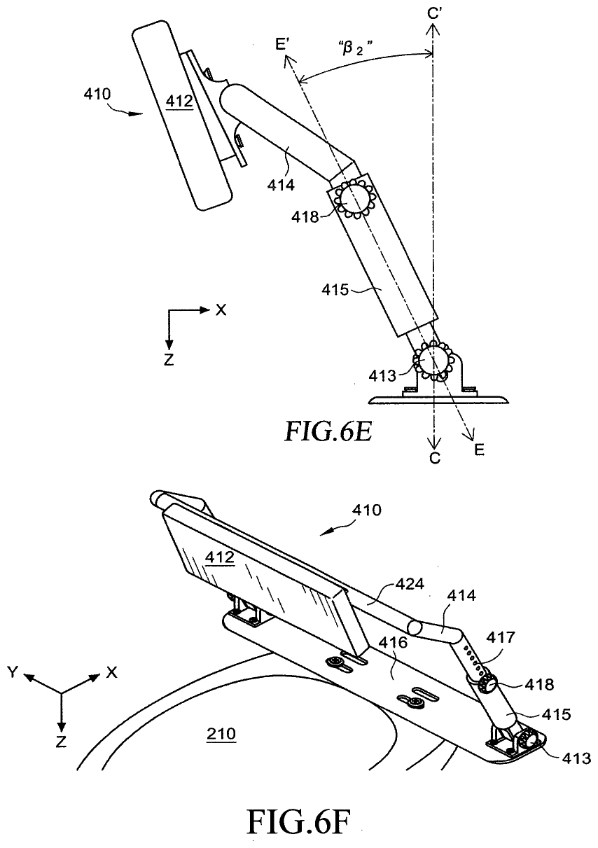

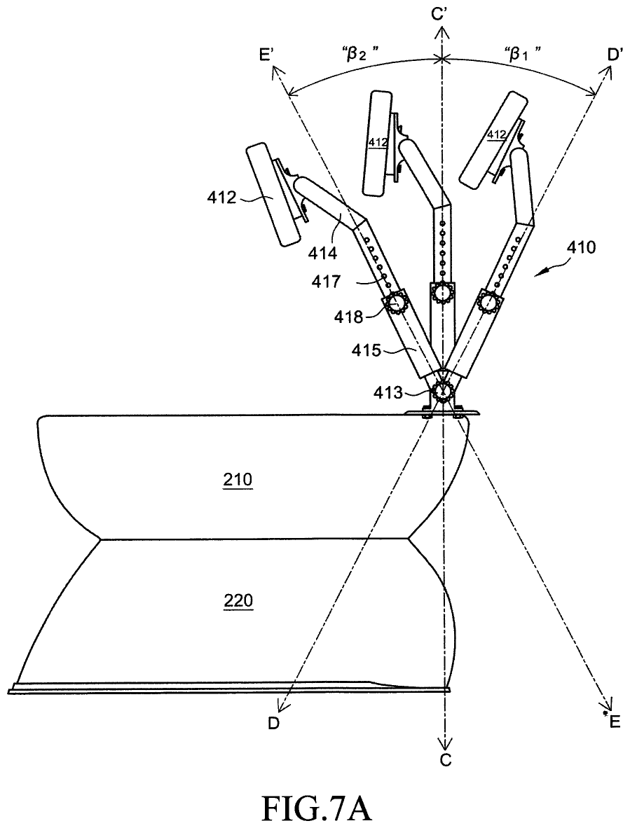

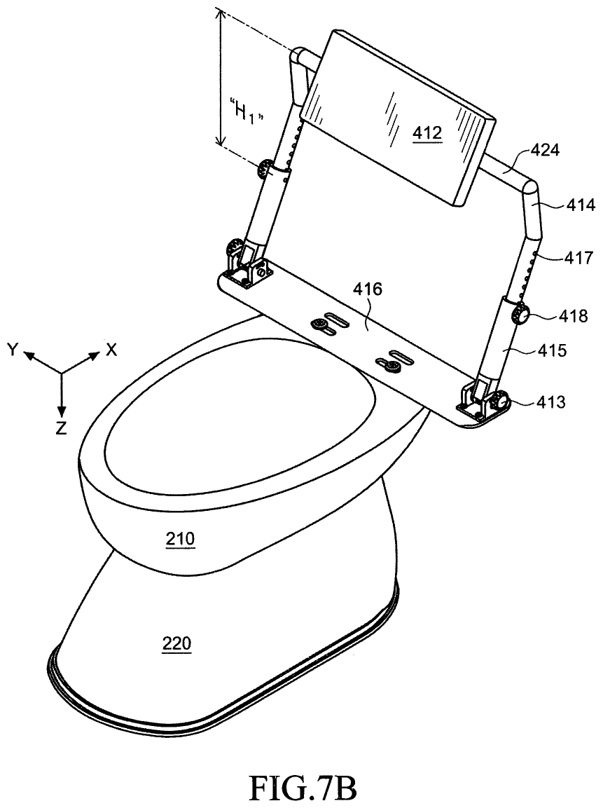

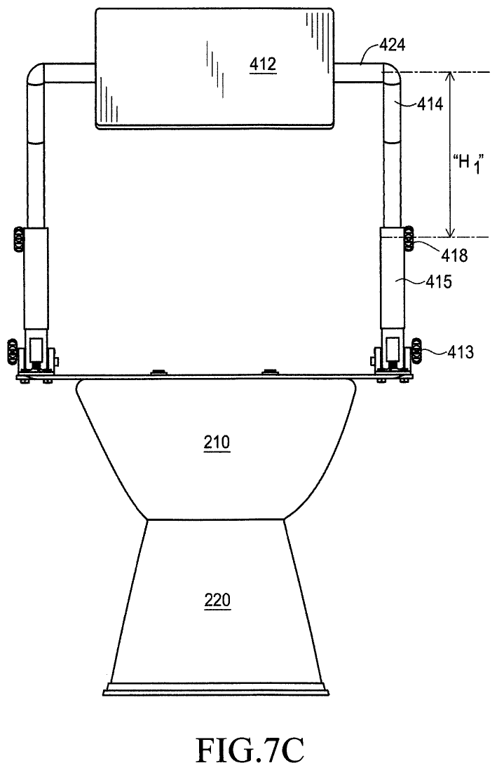

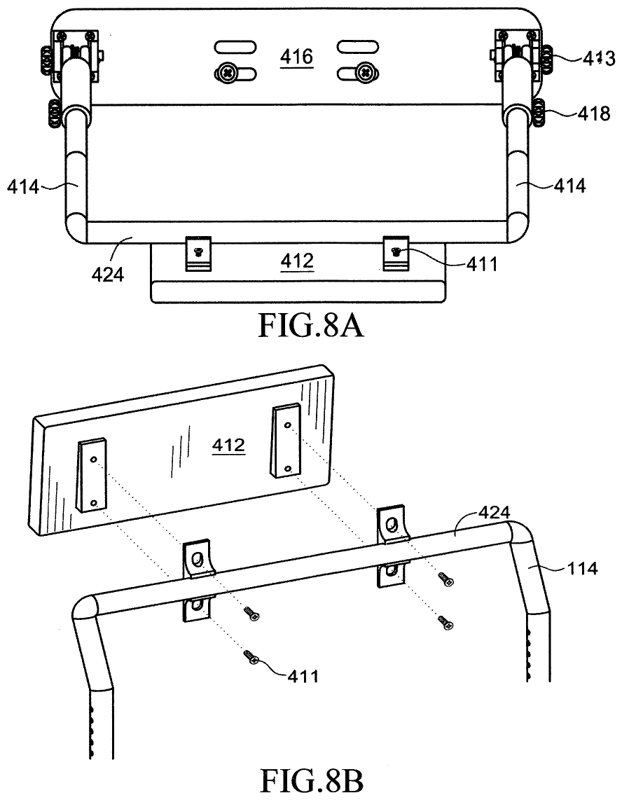

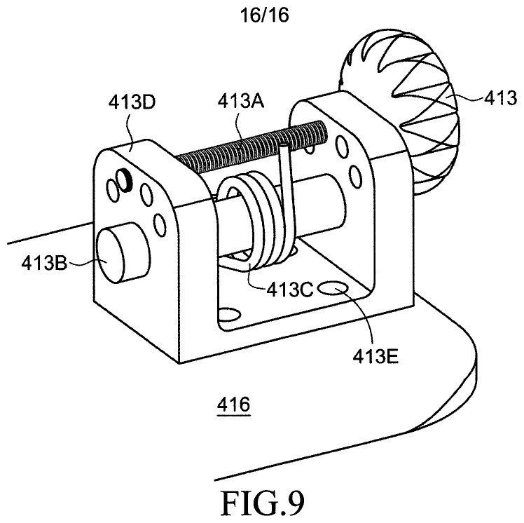

FIG. 9 is a sectional view of one example of an angle adjustment mechanism according to yet another embodiment of the invention.

### DETAILED DESCRIPTION

The present invention includes an assistive apparatus for providing a mechanism of backrest height adjustment while using assistive apparatus on top of a toilet. The present invention generally an assistive apparatus and a method of using the assistive apparatus. The assistive apparatus includes a back support portion comprises a backrest frame and a back pad attached on the backrest frame for supporting the human back. The backrest frame provides means for adjusting height of the back pad to accommodate different height of the human back. The angle adjustment portion connects to the back support portion with the toilet mounting portion and provides an angle adjustment means for different position of sitting on toilet. An assistive apparatus is disclosed to provide support for a human's back while sitting atop of a toilet. The assistive apparatus includes a back support portion, a height adjustment portion, an angle adjustment portion and a toilet mounting portion.

A method of using the assistive apparatus include following steps: i) a user lean against the assistive platform and press the “Down” button on a controller to lower the assistive apparatus platform; ii) once seated, the user can press the “Moving Up” or “Moving Down” button on the controller to adjust the height of a back rest pad to accommodate the user's back; iii) in addition, the user can press “Forward” or “Backward” button on the controller to adjust the angle of the support frame to accommodate the user's back; iv) after toileting is finished, the user can press the “Up” button on the controller to restore the right leaflet and a left leaflet to the original position and then lift the assistive platform up to assist the user in getting up from the toilet.

In one embodiment, the assistive apparatus includes one or more adjustable knobs are capable of moving from a first vertical position where the top support frame is at a base height (“1 H₀”) to a second vertical position where the top support frame is at a desirable height (“1 H₁”).

In another embodiment, the assistive apparatus further includes one or more angle adjust knobs connected to the bottom support frame and the support frame mounting base, wherein the one or more angle adjust knobs are adapted to adjust the angle of the support frame(top and bottom) between a first place (C) to a second place (D}, tiled at an angle (“β₁”); or a first place (C) to a third place (E), tiled at an angle (“β₂”) via an upper element of the top support frame

In a further embodiment, the assistive apparatus further includes a lifting assembly connected to the assistive platform and adapted to lift the assistive platform, wherein the lifting assembly comprising one or more lifting shafts adapted to lift the assistive platform so as to position the assistive platform tilted between a first stationery position to a second tilted position, tiled at an angle (“α”) horizontally. the “α” angle is adjusted to be between 0° and 80°.

The apparatus can be placed directly over a rim of a toilet bowl or a seat of a toilet seat system, a shower chair or a bedside commode. The back rest assembly with adjustment mechanism of the assistive apparatus as described in detail below can accommodates different personal height and back angle. When an individual person uses a toilet, the assistive apparatus with back rest assembly with adjustment mechanism described herein, the height of the back rest pad, and the angle of the back rest assembly, not only by the toilet but also the assistive apparatus of the current invention, thereby accommodates different personal height and back angle.

In addition, the assistive apparatus equipped with back rest assembly with adjustment mechanism is designed to be placed on any kinds of a toilet, any shower chairs, or other devices such that when a person uses the toilet the back rest assembly could be adjust to different height and angle.

FIG. 20A illustrates a perspective view of one example of an assistive apparatus 1100, which generally includes a backrest assembly 1110, a buttock-spreading mechanism 1120, a supporting leg mechanism 1140, and a lifting mechanism 1170. An individual person can operate the assistive apparatus 1100 for sitting down on top of the assistive apparatus 1100 and operating a controller 1180. For example, a person may sit on top of the assistive apparatus with the help of two or more armrests (e.g., grab handles 1192, 1194 being attached to the assistive platform 1150 of the assistive apparatus 1100), and control the assistive apparatus using the controller 1180. The controller 1180 can be a wireless remote control or a wired controller. As an example, the controller 1180 can be easily mounted and coupled to one of the grab handles 1192, 1194 for easy access and personal use.

The assistive apparatus 1100 can also include a power unit 1130, being positioned, for example, adjacent the supporting leg mechanism 1140 or near the base of a toilet. The power unit 1130 may contain internal electric circuits and one or more motors therein for providing powers and control circuits for operating the assistive apparatus 1100.

In one embodiment, the buttock-spreading mechanism 1120 includes a right leaflet 1122 and a left leaflet 1123 connected to a leaflet support base 1124, which is mounted on a top side of an assistive platform 1150. The leaflet support base 1124 includes a housing with one or more opening on one side for the right leaflet 1122 and the left leaflet 1123 connected thereto to be adjustably moving around by having at least one drive mechanism (e.g., drive mechanisms 1128A; 1128B, etc.) coupled or attached to the leaflet support base 1124. In addition, one or more actuators are positioned within the housing of the leaflet support base 1124 and connected to the right leaflet 1122 and the left leaflet 1123 for moving the right leaflet 1122 and the left leaflet 1123 connected thereto.

The supporting leg mechanism 1140 is adapted to support the assistive platform 1150 and includes two or more front supporting legs 1142. In some embodiment, the supporting leg mechanism 1140 may optionally include two or more back supporting legs 1147. In one embodiment, the front supporting legs 1142 and/or the back supporting legs 1147 can be secured on a platform or to the ground (e.g., via one or more floor mounting flange 1145 at the bottom ends of the front supporting legs 1142 and/or the back supporting legs 1147) for supporting the weight of the assistive apparatus 1100 and a person who may sit on top of the assistive apparatus 1100. Because of the strong structural support of the assistive apparatus, a suitable person's weight to be supported by the assistive apparatus 1100 may be a very large range of between 30 pounds and 300 pounds or larger, such as 100 pounds or larger, or 200 pounds or larger, etc.

Each of the front supporting legs 1142 and the back supporting legs 1147 is substantially vertical and may be physically joined to a floor mounting flange (e.g., the floor mounting flange 1145). The floor mounting flange 1145 is secured with four floor mounting bolts to prevent movement and ensure a stable foundation. Also, a connector 1143 can be coupled to each of the front supporting legs 1140 to join to a front bar 1148, which may be optionally jointed to a frame connector 1141 to prevent horizontal movement and vibration. The two front supporting legs 1140 connect to the assistive platform 1150 via a hinge 1146. This feature allows the assistive platform 1150 to be able to be tilt forward at an approximate angle of α° (as shown in FIG. 20B).

Two or more lifting mechanisms (e.g., a lifting mechanism 1170) are positioned on the both sides of the buttock-spreading mechanism 1120 and provided to support and lift the buttock-spreading mechanism 1120 from a horizontal position (e.g., as shown in FIGS. 20 and 21. To an elevated position (e.g., as shown in FIG. 22). The lifting mechanism 1170 may include one or more arms and/or lifting shafts (e.g., a lifting shaft 1171 and one or lifting shafts 1172 coupled together to be operated by an actuator assembly for lifting the buttock-spreading mechanism 1120 by raising the assistive platform 1150 between a horizontal position and an elevated/angled position (e.g., the assistive platform 1150 as shown in FIG. 20B).

The actuator assembly of the lifting mechanism 1170 may include a ball screw linear actuator 1174 and one or more nuts 1176, 1178 connected to the lifting shafts 1171, 1172 and adapted to lift the assistive platform 1150. The movement of the actuator assembly of the lift mechanism 1170 is driven by the power unit 1130. Optionally, the ball screw linear actuator 1174 may be positioned between the front supporting legs 1142 and the back supporting legs 1147 in order to connect the front supporting legs 1142 and the back supporting legs 1147 (e.g., via one or more connectors 1144) and provide structural support to the front supporting legs 1142 and/or the back supporting legs 1147.

In addition, the assistive apparatus 1100 can optionally include a back support (e.g., a backrest assembly 1110, etc.) suitable for a person sitting on top of the assistive apparatus 1100 to rest his or her back thereon. The backrest assembly 1110 can be mounted on top of a support frame mounting base 1116, which is positioned on top of the back supporting legs 1147. The backrest assembly 1110 on top of the support frame mounting base 1116 may include a top support frame 1114 and a bottom support frame 1115, which are connected together by one or more fastening elements (e.g., one or more fastening knob 1118). One or more holes 1117 are located on the top support frame 1114 and/or the bottom support frame 1115. In one embodiment, the height of the backrest assembly 1110 is adjustable, for example, by adjusting the connection of the top support frame 1114 and the bottom support frame 1115 via the adjustment of the positions of the holes 1117 coupled to the fastening knobs 1118). The backrest assembly 1110 may also include a back rest pad112, which can be a cushioned support for providing comfort and back support to the person sitting on top of the assistive apparatus 1100.

The backrest assembly 1110 which serves as a back support. The backrest assembly 1110 may include a backrest 1112, a top supporting frame 1114, a bottom supporting frame 1115, a support frame mounting base 1116, a hole 1117 and a fastening knob 1118 for height adjustment.

FIG. 20B is a perspective view of the assistive apparatus of FIG. 20A, where the buttock-spreading mechanism 1120 is adapted to be positioned in an elevated position on top of the toilet bowel 210. For example, the buttock-spreading mechanism 1120 can be elevated by the lifting mechanism 1170 attached to both sides of the assistive platform 1150 of the assistive apparatus 1100. The lifting mechanism 1170 is adapted to lift the assistive platform 1150, where one or more ball screw linear actuators 1174 of the lifting mechanism 1170 are adapted to expand and contract, thereby driving the lifting shafts 1171, 1172 up and down so as to adjust the height of the assistive platform 1150 and the buttock spreading mechanism 1120 thereon to an desirable elevated position. Thus, the assistive platform 1150, when being lifted to an elevated position, is adapted to be away from the support frame mounting base 1116 such that a line A-A′ (defined as from a top end of the front supporting leg 1142 to a top end of the back supporting leg 1147) and a line B-B′ (defined as from a top end of the front supporting leg 1142 to a bottom end of the assistive platform 1150) is crossed at an angle “α”. In one embodiment, as shown in FIG. 20B, the buttock-spreading mechanism 1120 can be positioned in an elevated position elevated at an angle “α”. In another embodiment, the buttock-spreading mechanism 1120 can be positioned on top of the toilet bowel 210 in a horizontal position (as shown in FIG. 20A, where the angle “α” equals to zero (0)).

FIG. 20C and FIG. 20D illustrates one example of a top portion of the buttock-spreading mechanism 1120 of the assistive apparatus 1100, where the right leaflet 1122 and the left leaflet 1123 are adapted to be moved and operated in a contracted position and an expanded position, respectively. As shown in FIGS. 20C-20D, the right leaflet 1122 and the left leaflet 1123 are connected to an actuator 1126A and an actuator 1126B, respectively, inside the housing of the leaflet support base 1124 via one or more openings 1127A, 1127B. A horizontal distance (“1 H”) between the right leaflet 1122 and the left leaflet 1123 can be adjustable via one or more drive mechanisms 1128A, 1128B positioned around the leaflet support base 1124, e.g., on both sides of the leaflet support base 1124. The one or more drive mechanisms 1128A, 1128B can be connected to one or more actuators 1126A, 1126B for driving and positioning the right leaflet 1122 and the left leaflet 1123, respectively.

The right leaflet 1122 and the left leaflet 1123 are positioned on a top side of the assistive platform 1155 and connected to one or more actuators (e.g., the actuators 1126A, 1126B) positioned within the leaflet support housing 1124. For example, the positions of the right leaflet 1122 and the left leaflet 1123 can be adjusted by the actuators 1126A, 1126B and the drive mechanisms 1128A, 1128B such that a horizontal distance between the mid portions of the right leaflet 1122 and the left leaflet 1123 is adjustably to between a first horizontal distance (“1H₁”), as shown in FIG. 20D, and a second horizontal distance (“1H2′), as shown in FIG. 20C.

In one embodiment, the one or more actuators 1126A, 1126B of the buttock-spreading mechanism 1120 are adapted to adjust a horizontal distance (“1H”) between the right leaflet 1122 and the left leaflet 1123 from the second horizontal distance (“H₂”) to the first horizontal distance (“H₁”), thereby spreading the buttocks of a person sitting on top of the buttock-spreading mechanism 1120. FIG. 25 illustrate an example for operating the drive mechanism 1128A and the actuator 1126A in a counterclockwise direction in order to move the right leaflet 1122 in an L₁ direction for spreading the buttocks of a person and expanding the right leaflet 1122 to an expanded position.

In another embodiment, the one or more actuators 1126A, 1126B of the buttock-spreading mechanism 1120 are adapted to adjust a horizontal distance (“1H”) between the right leaflet 1122 and the left leaflet 1123 from a first horizontal distance (“1H₁”) to a second horizontal distance (“1H₂”), thereby retracting the buttocks of a person sitting on top of the buttock-spreading mechanism 1120.

FIG. 21 illustrates a method of operating the height adjustment mechanism for the backrest assembly 1110 according to one or more embodiments of the invention. As shown in FIG. 21, the fastening knob 1118 is used to secure the position of the backrest 1112 by locking into the hole 1117. Once the highest height has been determined, the distance between the top supporting frame 1114 and the bottom supporting frame 1115 will be fixed at a height “1H₁”. As shown in FIG. 22, the distance between top supporting frame 1114 and the bottom supporting frame 1115 is at a height “1H₀” which the position of the backrest 1112 is at the lowest level. To ensure the stability, the bottom supporting frame 1115 is secured on the support frame mounting base 1116 with a bolt 1119.

In addition, FIG. 21 shows the lifting mechanism 1170 comprising a top supporting shaft 1171, two bottom supporting shafts 1172A & 11726, a ball screw linear actuator 1174 driven by the power unit 1130, and two nuts 1176 & 1178. To ensure a stable foundation, the ball screw linear actuator 1174 connects to the front supporting leg 1142 via a connector 1144, and the front bar 1148 connects to the front supporting leg 1142 via a connector 1143 on the both sides. The assistive platform is also connected to the front supporting leg 1142 with a hinge 1146 which enables the assistive platform 1150 to tilt forward while a user uses a controller 1180 to activate the lifting mechanism 1170.

FIG. 22 illustrates a method of operating the height adjustment mechanism according to one or more embodiments of the invention. As shown in FIG. 22, the fastening knob 1118 is used to secure the position of the backrest 1112 by locking into the hole 1117. Once the highest height has been determined, the distance between the top supporting frame 1114 and the bottom supporting frame 1115 will be fixed at a height “1 H₁”. As shown in FIG. 22, the distance between top supporting frame 1114 and the bottom supporting frame 1115 is at a height “H₀” which the position of the backrest 1112 is at the lowest level. To ensure the stability, the bottom supporting frame 1115 is secured on the support frame mounting base 1116 with a bolt 1119.

FIG. 22 also shows the lifting mechanism 1170 comprising a top supporting shaft 1171, two bottom supporting shafts 1172A & 1172B, a ball screw linear actuator 1174 driven by the power unit 1130, and two nuts 1176 & 1178. To ensure a stable foundation, the ball screw linear actuator 1174 connects to the front supporting leg 1142 via a connector 1144, and the front bar 1148 connects to the front supporting leg 1142 via a connector 1143 on the both sides. The assistive platform is also connected to the front supporting leg 1142 with a hinge 1146 which enables the assistive platform 1150 to tilt forward while a user uses a controller 1180 to activate the lifting mechanism 1170.

FIG. 23A illustrates a perspective view of the backrest assembly 1110 of the present invention is shown. FIG. 23A shows the distance between the top supporting frame 1114 and the bottom supporting frame 1115 is at a height “1H₁” when the backrest 1112 is at the highest level. FIG. 23B shows the distance between the top supporting frame 1114 and the bottom supporting frame 1115 is at a height “1H₀” when the backrest 1112 is at the lowest level.

FIG. 23B illustrates a perspective view of the backrest assembly 1110 of the present invention is shown. FIG. 23A shows the distance between the top supporting frame 1114 and the bottom supporting frame 1115 is at a height “1H₁” when the backrest 1112 is at the highest level. FIG. 23B shows the distance between the top supporting frame 1114 and the bottom supporting frame 1115 is at a height “1H₀” when the backrest 1112 is at the lowest level.

FIG. 24A illustrates a perspective view of a universal backrest assembly 1410 of the present invention is shown. The universal backrest assembly 1410 includes a backrest 1412, a bottom fasten knob 1413 for angle adjustment, a top supporting frame 1414, a bottom supporting frame 1415, a support frame mounting base 1416, a hole 1417, a top fasten knob 1418 for height adjustment, and an upper connect support frame 1424. As shown in FIG. 24A, the distance between the top supporting frame 1414 and the bottom supporting frame 1415 is at a height “1H₁” when the backrest 1412 is at the highest level. FIG. 24B shows the distance between the top supporting frame 1414 and the bottom supporting frame 1415 is at a height “1H₀” when the backrest 1412 is at the lowest level.

FIG. 24B illustrate a perspective view of a universal backrest assembly 1410 of the present invention is shown. The universal backrest assembly 1410 includes a backrest 1412, a bottom fasten knob 1413 for angle adjustment, a top supporting frame 1414, a bottom supporting frame 1415, a support frame mounting base 1416, a hole 1417, a top fasten knob 1418 for height adjustment, and an upper connect support frame 1424. As shown in FIG. 24A, the distance between the top supporting frame 1414 and the bottom supporting frame 1415 is at a height “1H₁” when the backrest 1412 is at the highest level. FIG. 24B shows the distance between the top supporting frame 1414 and the bottom supporting frame 1415 is at a height “1H₀” when the backrest 1412 is at the lowest level.

FIG. 25A illustrate a side view of the highest and lowest height of the universal backrest assembly 1410 of the present invention is shown in a vertical state. FIG. 25A shows an axis line C-C′ represents the axis of the bottom supporting frame 1415. An axis line E-E′ represents the axis of the top supporting frame 1414. The angle between the axis line C-C′ and axis line E-E′ is “γ”.

FIG. 25B illustrate a side view of the highest and lowest height of the universal backrest assembly 1410 of the present invention is shown in a vertical state. FIG. 25A shows an axis line C-C′ represents the axis of the bottom supporting frame 1415. An axis line E-E′ represents the axis of the top supporting frame 1414. The angle between the axis line C-C′ and axis line E-E′ is “γ”.

FIG. 25C illustrate a side view of the highest and lowest height of the universal backrest assembly 1410 of the present invention is shown in a backward tilt state. The axis line C-C′ represents a vertical axis. An axis line D-D′ represents the axis of the bottom supporting frame 1415 in a backward tilt state. The angle between the axis line C-C′ and axis line D-D′ is “β₁”.

FIG. 25D illustrate a side view of the highest and lowest height of the universal backrest assembly 1410 of the present invention is shown in a backward tilt state. The axis line C-C′ represents a vertical axis. An axis line D-D′ represents the axis of the bottom supporting frame 1415 in a backward tilt state. The angle between the axis line C-C′ and axis line D-D′ is “β₁”.

FIG. 25E, a side view of the universal backrest assembly 1410 at lowest level of the present invention is shown in a forward tilt state. The axis line C-C′ represents a vertical axis. And the axis line E-E′ represents the axis of the bottom supporting frame 1415 in a forward tilt state. The angle between the axis line C-C′ and axis line D-D′ is “β₂”.

FIG. 25F shows a perspective view of the universal backrest assembly 1410 of the present invention in a forward tilt state.

FIG. 26A illustrates a method of operating the angle adjustment mechanism according to one or more embodiments of the invention. When the universal backrest assembly 1410 rotate from a vertical state to a backward tilt sate, the axis line C-C′ will rotates to the axis line D-D′ at an angle of “β₁”. When the universal backrest assembly 1410 rotates from a vertical state to a forward tilt sate, the axis line C-C′ will rotate to the axis line E-E′ at an angle of “β₂”.

Referring to FIG. 26B, a perspective view of the universal backrest assembly 1410 of the present invention and a toilet is shown in a backward tilt state. The distance between the top supporting frame 1414 and the bottom supporting frame 1415 is at a height “1 H₁” so the backrest 1412 is at the highest level.

Referring to FIG. 26C, a front view of the universal backrest assembly 1410 of the present invention and a toilet is shown. The distance between the top supporting frame 1414 and the bottom supporting frame 1415 is at a height “1H₁” so the backrest 1412 is at the highest level.

FIG. 27A illustrate the assembly of the backrest assembly 1410 is shown. FIG. 27A shows a top view of the universal backrest assembly 1410 of the present invention. FIG. 27B shows a back perspective view of the universal backrest assembly 1410. The upper connect support frame 1424 is physically joined to top supporting frame 1414 and connects to the back rest 1412 by means of mounting bolts 1411.

FIG. 27B illustrate the assembly of the backrest assembly 1410 is shown. FIG. 27A shows a top view of the universal backrest assembly 1410 of the present invention. FIG. 27B shows a back perspective view of the universal backrest assembly 1410. The upper connect support frame 1424 is physically joined to top supporting frame 1414 and connects to the back rest 1412 by means of mounting bolts 1411.

FIG. 28 illustrate a sectional view of another example of the angle adjustment mechanism of the present invention. The bottom fasten knob 1413 is locked into a connecting wing 1413D with a knob screw 1413A to prevent a bolt 1413B and a spring roll 1413E from rotating. When the bottom fasten knob 1413 is removed by a user, it allows the bottom supporting frame 1415 (see FIG. 26A) to rotate freely through the connecting wing 1413D. Also, the spring roll 1413E may pull the bottom supporting frame 1415 back to predetermined angle if there is no any pressure from the user. The user may stick back the bottom fasten knob 1413 and the knob screw 1413A into the connecting wing 1413D as to lock in the bottom supporting frame 1415 by desired position.

While the foregoing is directed to embodiments of the present invention, other and further embodiments of the invention may be devised without departing from the basic scope thereof, and the scope thereof is determined by the claims that follow.

1. An assistive apparatus, comprising:
a back rest assembly comprising:
a back rest pad;
a top support frame connected to the back rest pad;
a bottom support frame connected to the top support frame with one or more adjustable knobs; and
a support frame mounting base connected to the bottom support frame.

2. The assistive apparatus of claim 1, further comprising:
one or more back supporting legs connected to the support frame mounting base.

3. The assistive apparatus of claim 2, further comprising:
one or more floor mounting flanges, wherein each back supporting leg is substantially vertical and physically joined to the one or more floor mounting flanges.

4. The assistive apparatus of claim 1, wherein the one or more adjustable knobs are capable of moving from a first vertical position where the top support frame is at a base height (“1H₀”) to a second vertical position where the top support frame is at a desirable height (“1H₁”).

5. The assistive apparatus of claim 1, wherein the top support frame is designed to be angled at an angle (“r”) between the top support frame and a vertical line (C-C′), and wherein the angle “r” is between zero to 45 degree.

6. The assistive apparatus of claim 1, further comprising:
one or more angle-adjusting fastening knobs connected to the bottom support frame and the support frame mounting base, wherein the one or more angle adjust knobs are adapted to adjust the angle (“β”) between the bottom support frame and a vertical line (C-C′).

7. The assistive apparatus of claim 6, wherein the angle “β” equals to an angle “β₁”, ranging between zero degree to 89 degree.

8. The assistive apparatus of claim 6, wherein the angle “β” equals to an angle “β₂”, ranging between zero degree to negative 89 degree.

9. The assistive apparatus of claim 1, further comprising:
a buttock-spreading mechanism.

10. The assistive apparatus of claim 9, further comprising:
one or more front supporting legs connected the buttock-spreading mechanism.

11. The assistive apparatus of claim 1, further comprising:
a front bar connected to the one or more front supporting legs.

12. The assistive apparatus of claim 9, wherein the buttock-spreading mechanism comprises:
an assistive platform;
a right leaflet being positioned on a top side of the assistive platform and connected to the one or more actuators within the leaflet support housing; and
a left leaflet being positioned on the top side of the assistive platform and connected to the one or more actuators within the leaflet support housing, wherein the one or more actuators are adapted to adjust a horizontal distance (“1H”) between the left leaflet and the right leaflet, wherein the horizontal distance (“1H”) is
adjustable between a first horizontal distance (“1H₁”) and a second horizontal distance (“1H₂”).

13. The assistive apparatus of claim 12, further comprising:
a lifting mechanism being connected to the buttock-spreading mechanism and adapted to lift the buttock-spreading mechanism.

14. The assistive apparatus of claim 13, wherein the lifting mechanism comprises:
one or more lifting shafts adapted to lift the buttock-spreading mechanism so as to position an assistive platform of the buttock-spreading mechanism to be tilted at an angle (“α”).

15. The assistive apparatus of claim 14, wherein the “α” angle is adjusted to be between 0° and 80°.

16. The assistive apparatus of claim 14, wherein the lifting assembly further comprises:
one or more ball screw linear actuators; and
one or more nuts connected to the one or more lifting shafts.
